(19) United States
(12) Patent Application Publication
(10) Pub. No.: US 2007/0268098 A1
(43) Pub. Date: Nov. 22, 2007

(54) SPACE ALLOCATION FOR SWITCHING APPARATUS

(75) Inventors: Manick Ghosh, Bangalore (IN); Victor Elviro, Madrid (ES); Jorge Bonilla, Madrid (ES); Prashant Zende, Bangalore (IN); Ranjit Deshmukh, Bangalore (IN); Javier Gomez, Madrid (ES)

Correspondence Address: CANTOR COLBURN, LLP, 55 GRIFFIN ROAD SOUTH, BLOOMFIELD, CT, 06002, US

(73) Assignee: GENERAL ELECTRIC COMPANY, Schenectady, NY (US)

(21) Appl. No.: 11/559,065

(22) Filed: Nov. 13, 2006

(30) Foreign Application Priority Data
May 19, 2006 (ES) PCT/ES06/00263

(51) Int. Cl. H01H 75/00

(52) U.S. Cl. 335/6

(57) ABSTRACT

A housing for a single-pole circuit breaker is disclosed. The housing includes two current path regions, each region having a first section configured to receive an electromagnetic protection device, a second section configured to receive a thermal protection device, a third section configured to receive an arc extinguishing device, and a fourth section configured to receive an operating mechanism device. Each first section occupies a substantial part of the available internal width of the housing, and is disposed between the respective third and fourth sections. Each second section occupies about half the available internal width of the housing.

### BACKGROUND OF THE INVENTION

The present disclosure relates generally to switching devices, and particularly to circuit breakers. Extensive use of circuit breakers has promoted the development of standardized circuit breaker housing dimensions. For example, it is common that single pole circuit breakers sold in Europe for residential and/or lighting applications are contained within housings that are 18 millimeters wide. Similarly, it is common that single pole circuit breakers sold in the US for residential and/or lighting applications are contained within housings that are 0.75 inches wide. With careful allocation of the internal space, it is possible to increase the number of circuit protection devices within a housing of given envelope dimensions. For example, many modules having the standardized envelope dimensions to incorporate a single power pole now additionally include protection for a neutral pole. Further, modules that have two active power poles within the standard housing dimensions for a single pole breaker have been developed. Multi-sectional housings may include a partition surface that provides a lateral division within the housing, preferably in the middle to provide an equal volume distribution. Other allocation methods have been developed that may provide unequal volume distributions. Space constraints within the housing may have functional effects upon the devices contained therein. Accordingly, the art may be advanced by an optimized space arrangement within a circuit breaker.

### BRIEF DESCRIPTION OF THE INVENTION

An embodiment of the invention includes a housing for a single-pole circuit breaker. The housing includes two current path regions, each region having a first section configured to receive an electromagnetic protection device, a second section configured to receive a thermal protection device, a third section configured to receive an arc extinguishing device, and a fourth section configured to receive an operating mechanism device. Each first section occupies a substantial part of the available internal width of the housing, and is disposed between the respective third and fourth sections. Each second section occupies about half the available internal width of the housing.

Another embodiment of the invention includes a circuit breaker with a single-pole housing. The housing includes two current path regions, each region comprising a first section configured to receive an electromagnetic protection device, a second section configured to receive a thermal protection device, a third section configured to receive an arc extinguishing device, and a fourth section configured to receive an operating mechanism device. The circuit breaker further includes two electromagnetic protection devices, each disposed within the first section of each current path region, two thermal protection devices, each disposed within the second section of each current path region, two arc extinguishing devices, each disposed within the third section of each current path region, each device defining a portion of the current path within each current path region. An operating mechanism device is disposed within the fourth section of each current path region, configured to open and close the current path of each current path region. Each first section occupies a substantial part of the available internal width of the housing and is disposed between the respective third and fourth sections. Each second section occupies about half the available internal width of the housing.

### BRIEF DESCRIPTION OF THE DRAWINGS

Referring to the exemplary drawings wherein like elements are numbered alike in the accompanying Figures:

FIG. 1 depicts a top perspective exploded view of a circuit breaker in accordance with an embodiment of the invention;

FIG. 2 depicts a six view orthographic layout of a circuit breaker housing in accordance with an embodiment of the invention;

FIG. 3 depicts a side perspective internal view of a circuit breaker, in accordance with an embodiment of the invention;

FIG. 4 depicts a side perspective of the circuit breaker of FIG. 3 with some parts removed for clarity, in accordance with an embodiment of the invention;

FIG. 5 depicts a schematic circuit diagram of a circuit breaker connection arrangement in accordance with an embodiment of the invention; and

FIG. 6 depicts a schematic circuit diagram of a circuit breaker connection arrangement in accordance with an embodiment of the invention.

### DETAILED DESCRIPTION OF THE INVENTION

An embodiment of the invention provides a single-pole circuit breaker with two current path regions. In an embodiment, the circuit breaker has envelope dimensions meeting the standards for circuit breakers with one pole, with an equal utilization of the internal space for each current path region. Each current path region within the circuit breaker includes both thermal and electromagnetic protection devices. In an embodiment, the circuit breaker accommodates two coils to provide electromagnetic protection, one coil for each current path region. In an embodiment, each coil has a round cross-section that consumes all or substantially all of the available internal width of the single-pole circuit breaker housing. An embodiment of the invention provides two bimetallic strips for thermal protection, one bimetal for each current path region, and two arc chambers, one for each current path region, to extinguish any arcs generated during breaker activation. An embodiment of the invention is configured to provide double protection to a single circuit. Another embodiment of the invention is configured to provide full protection to a three-phase circuit, or a three-phase circuit with switching neutral.

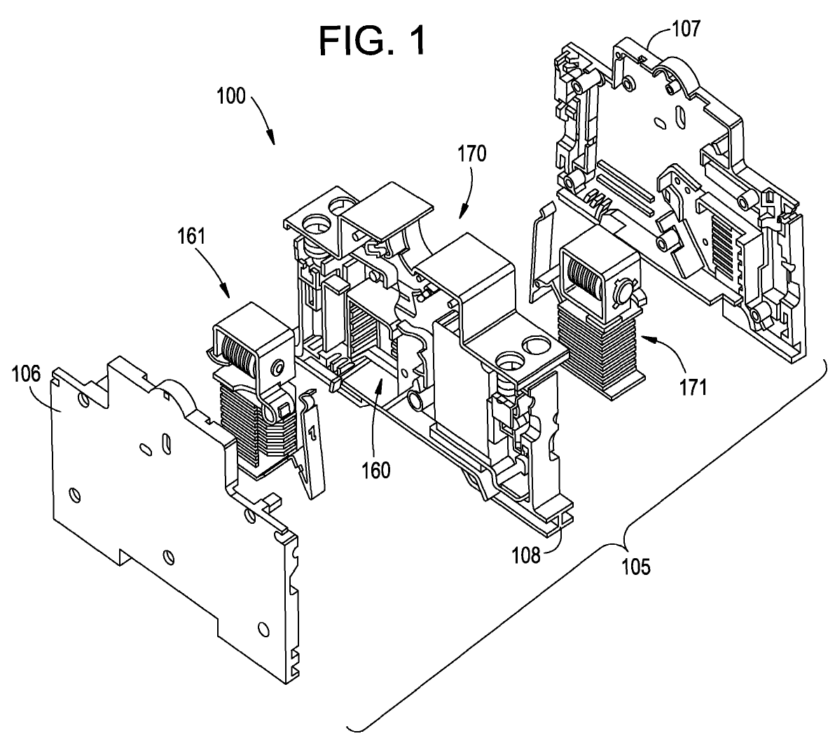

Referring to FIG. 1, an exploded assembly view of an exemplary embodiment of a circuit breaker 100 is depicted. Two sides 106, 107, and a center 108 collectively form a circuit breaker housing 105. The circuit breaker housing 105 includes two current path regions 160, 170 to provide space and support for two circuit protection devices 161, 171, which will be described in more detail below. In an embodiment, the circuit breaker housing 105 has dimensions that are the same as standardized single-pole circuit breakers 100, such as 18 millimeters wide in Europe and 0.75 inches wide in the US, for example. In accordance with embodiments of the invention, and to be discussed in more detail below, two current path regions 160, 170 are contained within one of the circuit breaker housing 105.

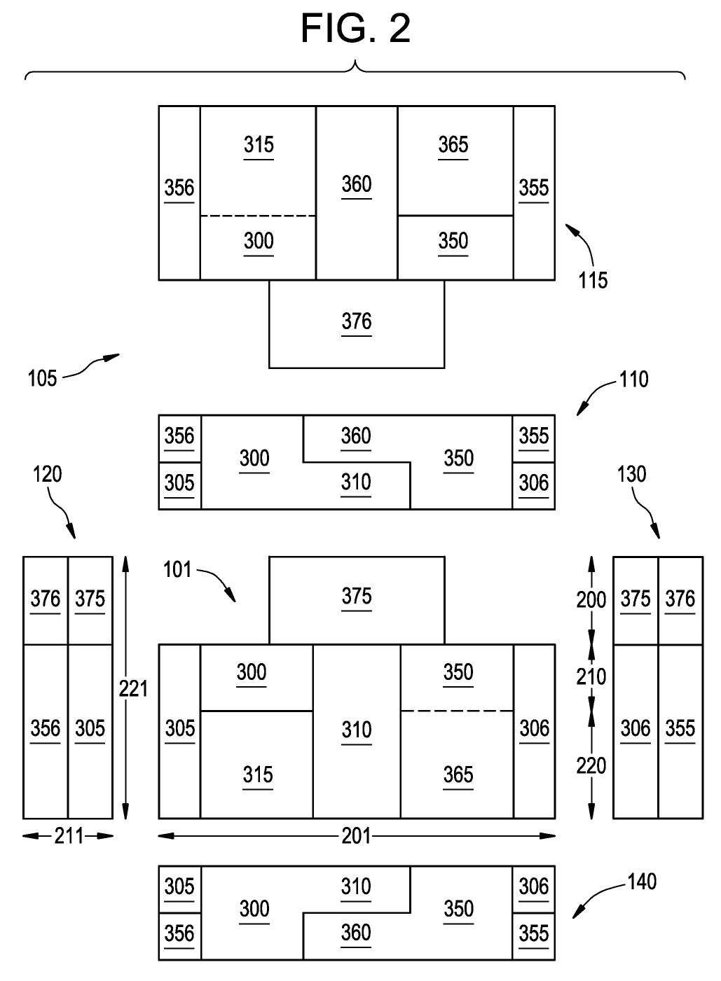

Referring now to FIG. 2, an illustration of the internal space layout of the exemplary circuit breaker housing 105 is depicted in a six-view orthographic projection. Each view is divided into sections configured to receive portions of the devices 161, 171 for a circuit breaker 100. A first side view 101, top view 110, second side view 115, left view 120, light view 130, and bottom view 140 of the circuit breaker housing 105, are depicted utilizing third angle projection. A length, width, and height of the circuit breaker housing 105 are identified by reference numerals 201, 211, and 221, respectively. Additionally, the circuit breaker 100 may be broken into a top zone 200, middle zone 210, and bottom zone 220 which will assist in describing the allocation of space within the circuit breaker 100. The top view 110 and bottom view 140 indicate essentially the division of space within the middle zone 210 and bottom zone 220. Details regarding the specific devices 161, 171 within each section will be discussed further below.

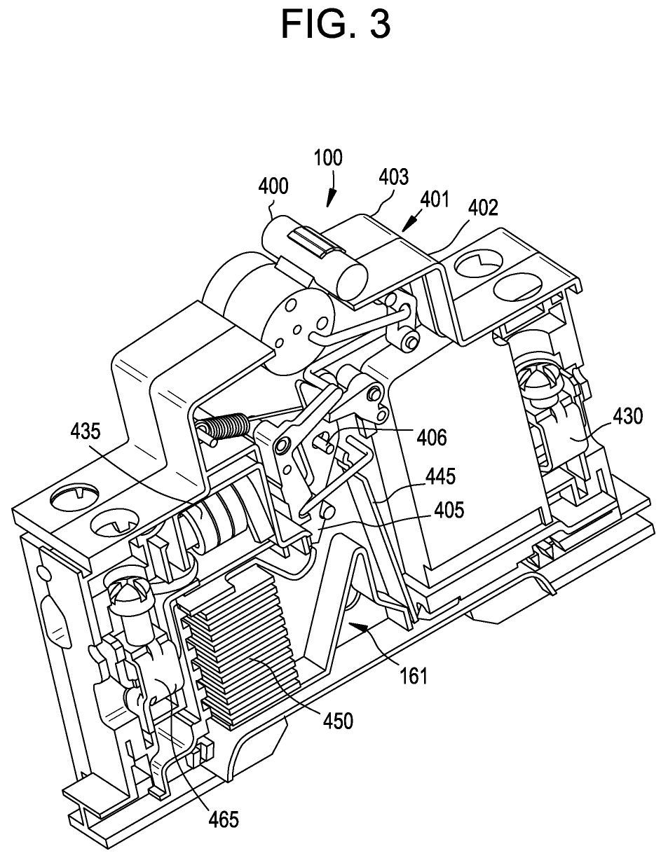

Referring now to FIG. 3, an exemplary embodiment of the circuit breaker 100 with the device 161 disposed within the current path region 160 is depicted. An actuator 400 is in mechanical communication with an operating mechanism device (also herein referred to as a mechanism) 401 to control the position of a movable contact arm 405 about a pivot pin 406. As used herein, reference numeral 401 may refer to either a first 402 portion or a second portion 403 of the mechanism 401 in conjunction with each individual circuit protection device 161, 171. In an embodiment, the operating mechanism 401 is configured and disposed via first and second portions 402, 403 so as to provide a “common trip” function, to allow both circuit protection devices 161, 171 to trip together in response to a trip event in either circuit protection device 161, 171. In an embodiment, the actuator 400 is configured to allow manual opening and closing of the current path in the first and second current path regions 160, 170 together.

In an embodiment, an arc extinguishing device (also herein referred to as an arc chute) 450, may, and is allowed to, consume a substantial portion of the full internal width 211 of the circuit breaker 100, and extinguishes arcs that may be created during a trip event of the circuit breaker 100. A thermal protection device (also herein referred to as a bimetallic strip) 445 may consume up to about half of the circuit breaker 100 internal width 211, and provides circuit protection via thermal trip action. An electromagnetic protection device (also herein referred to as a coil) 435 may, and is allowed to, consume a substantial portion of the full internal width 211 of the circuit breaker 100, and provide circuit protection via electromagnetic trip action. A first circuit connection 465 is associated with the coil 435, and a second circuit connection 430 is associated with the bimetallic strip 445, the circuit connections 465, 430 configured to allow for power connections to the circuit breaker 100. It will be appreciated that although it is not visible in the perspective of FIG. 3, the circuit breaker 100 will utilize a second contact arm 405, arc chute 450, bimetallic strip 445, coil 435, first circuit connection 465, and second circuit connection 430 for the other current path region 170, which is located behind (into the paper) the plane depicted in FIG. 3.

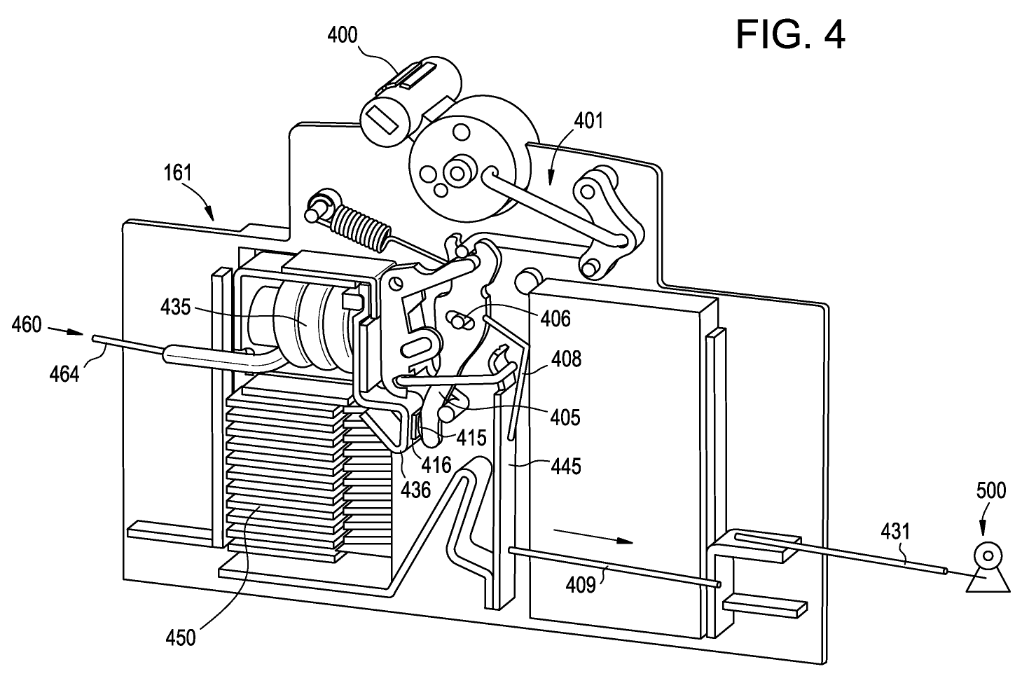

Referring now to FIG. 4, a current path 460 through an exemplary embodiment of the circuit protection device 161, disposed in the current path region 160 of the circuit breaker housing 105 is depicted. Current is supplied via a line conductor 464 in power connection with the first circuit connection 465, (which is best seen in reference to FIG. 3) which is connected to the coil 435. The coil 435 is in power connection with a contact holder 436 upon which a fixed contact 416 is disposed. Current will then flow from the fixed contact 416 to a movable contact 415 disposed upon the contact arm 405. Current will then flow through the contact arm 405, through conductor 408 and to the bimetallic strip 445. The current will continue through a conductor 409 to the second circuit connection (best seen by reference to FIG. 3), through conductor 431 to a load 500. As used herein, reference numeral 500 may refer to any appropriate electrical load, such as a lighting fixture, one-phase, or three-phase motor, for example. The contact arm 405 in FIG. 4 is depicted in a CLOSED position, to allow current flow through the current path 460. It will be appreciated that in response to a counter-clockwise rotation of the contact arm 405 about the pivot 406, a mechanical and electrical separation between fixed contact 416 and movable contact 415 will result, thereby defining an OPEN position to interrupt the flow of current.

In an exemplary embodiment, the actuator 400 is in mechanical connection with the mechanism 401 that controls the position of the contact aim 405 in a manner known in the art. In response to the actuator 400 being moved to an ON position, the mechanism 401 will cause the contact arm 405 to rotate in a clockwise direction about the pivot 406, providing mechanical and electrical connection between the fixed contact 416, and the movable contact 415, creating the CLOSED current path 460. Alternatively, in response to the actuator 400 being moved to an OFF position, the mechanism 401 will cause the contact arm 405 to rotate in a counter clockwise direction about pivot 406, separating the mechanical and electrical connection between the fixed contact 416 and the movable contact 415, creating an OPEN current path 460, thereby preventing the flow of current within the current path 460.

While an exemplary embodiment of a circuit protection device has been described depicting a single contact arrangement utilizing a contact arm with one movable contact to interrupt current via rotary motion, it will be appreciated that the scope of the invention is not so limited, and that the invention also applies to other methods to interrupt current flow, such as contact arms that may utilize linear motion, or alternate contact arrangements, such as double contacts, for example. Further, while an exemplary embodiment has been described depicting an arc extinguishing device with one arc chute, it will be appreciated that the scope of the invention is not so limited, and that the invention also applies to other arc extinguishing arrangements, such as an extinguishing device with two arc chutes, for example. Additionally, while the exemplary embodiment described depicts a single actuator to engage multiple mechanisms, each mechanism in operable communication with a respective circuit protection device, it will be appreciated that the scope of the invention is not so limited and that the invention will also apply to circuit breakers that may employ alternate arrangements, such as a single actuator to engage a single mechanism in conjunction with multiple circuit protection devices, or multiple circuit protection devices, each with an individual mechanism and actuator, for example.

In an embodiment, the circuit breaker 100 provides electromagnetic circuit protection via the coil 435. In response to a large increase in current (as may result from a short-circuit) the coil 435 is configured to activate the mechanism 401, which, in turn, will rotate the contact arm 405 to the OPEN position, thereby interrupting the current path 460 to prevent any subsequent current flow. The circuit breaker 100 provides thermal protection via the bimetallic strip 445. As current flows through the bimetallic strip 445, heating will occur as a result of the material resistance. This heating will cause a defined displacement at the free end of the bimetallic strip 445. If the current (and heating) exceed a defined threshold, the displacement of the bimetallic strip 445 will activate the mechanism 401 to rotate the contact arm 405 to the OPEN position, thereby interrupting the current path 460. In the art, the opening action via the coil or bimetal due to an overcurrent condition is referred to as a trip action.

The bimetallic strip 445 depicted in the exemplary embodiment of FIG. 4 depicts the conductors 408, 409 arranged so as to allow the current to flow through the length of the bimetallic contact, which is known in the art as a “direct heating” arrangement. It will be appreciated by one skilled in the art that alternate methods of conductor 408, 409 connection may be employed, such as “indirect heating”, whereby the conductors 408, 409 are both attached at the end opposite the free end such that the length of current flow is comparatively short, and the resulting heat is transferred via thermal conduction within the bimetallic strip 445.

While an exemplary embodiment has been described with current flow through circuit protection device 161 in a first direction, it will be appreciated that scope of the invention is not so limited, and that the invention also applies to a circuit protection device through which current may flow in the opposite direction. While the current path has been described for one circuit protection device 161, it will be appreciated that an exemplary embodiment of the invention employs two similar circuit protection devices 161, 171, as depicted in FIG. 1 for example.

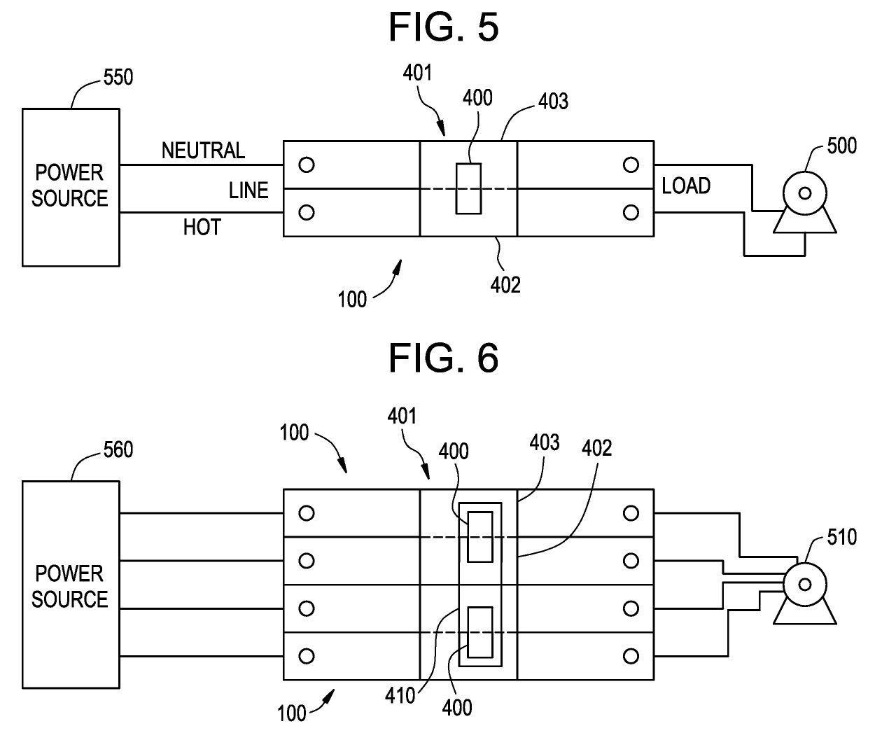

Referring now to FIG. 5, a schematic circuit utilizing an exemplary embodiment of the circuit breaker 100 is depicted. In the exemplary circuit of FIG. 5, the circuit breaker 100 is configured to provide double circuit protection to the load 500 as connected to a power supply 550.

Referring now to FIG. 6, a schematic circuit utilizing an exemplary embodiment of the circuit breaker 100 is depicted. In the exemplary circuit of FIG. 6, two circuit breakers 100 are configured to provide complete circuit protection to a three-phase load 510 as connected to a three-phase power supply 560, depicted in FIG. 6 with a switching neutral. An optional actuator tie 410 may be utilized to synchronize the application and removal of power to the circuit.

Referring now back to FIG. 1, the allocation of space within an exemplary embodiment of the circuit breaker housing 105 will be described. The circuit interruption devices 161, 171 have been configured to allow configuration of the circuit breaker housing 105 to provide current path regions 160, 170 that occupy the same amount of internal volume. Within each current path region 160, 170, six sections are configured to receive each individual component of each of the circuit interruption devices 161, 171. Referring now to FIG. 2 in conjunction with FIG. 4, in an embodiment, a first section 300, 350 for each current path region 160, 170, respectively, is configured to receive the coil 435 of the circuit interruption devices 161, 171. A second section 310, 360 is configured to receive the bimetallic strip 445. A third section 315, 365 is configured to receive the arc chute 450. A fourth section 375, 376 is configured to receive the mechanism 401. A fifth section 305, 355 is configured to receive the first circuit connection 465, and a sixth section 306, 356 is configured to receive the second circuit connection 430. It will be appreciated that as a result of the mirror arrangement of the devices 161, 171 within the housing 105 that each fifth section 305, 355 is diagonally opposed (disposed at opposing ends of the housing 105 relative to the length 201 and width 211 of the housing 105). Similarly, each sixth section 306, 356 is diagonally opposed.

In an embodiment, each first section 300, 350 shall occupy a substantial portion of the circuit breaker housing 105 width 211, and be disposed between the respective third sections 315, 365 and the fourth sections 375, 376. Further, each first section 300, 350 shall be disposed between the respective second sections 310, 360 and the fifth sections 305, 355. As used herein, the term “substantial” represents all of the functionally useful internal width considering the size and geometry of the coil 435.

In an embodiment, each second section 310, 360 shall occupy about half the width 211 of the circuit breaker housing 105, and be disposed between the respective first sections 300, 350 and sixth sections 306, 356. Further, each second section 310, 360 shall be centrally disposed within the circuit breaker housing 105 relative to the length 201 of the housing 105, and shall be side by side each other relative to the width 211 of the housing 105. Each third section 315, 365 shall occupy a substantial part of the available internal width 211 of the housing 105, and be disposed at opposing sides relative to the circuit breaker housing 105 length 201 between the respective second sections 310, 360 and fifth sections 305, 355. As used herein, the term “about” represents a minimum deviation that may result from manufacturing and material tolerances, for example.

As disclosed, some embodiments of the invention may include some of the following advantages: double thermal and electromagnetic circuit protection in a compact housing; the ability to utilize two coils of circular cross section, each configured to fit the entire internal housing width; and, the ability to divide internal volume equally within a housing.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A housing for a single-pole circuit breaker, the housing having a length, width and height, the housing comprising:
two current path regions, each region comprising a first section configured to receive an electromagnetic protection device, a second section configured to receive a thermal protection device, a third section configured to receive an arc extinguishing device, and a fourth section configured to receive an operating mechanism device;
wherein each first section is disposed between the respective third and fourth sections;
wherein each first section occupies a substantial part of the available internal width of the housing; and
wherein each second section occupies about half the available internal width of the housing.

2. The housing of claim 1, wherein:
the two current path regions each further comprise a fifth section configured to receive first circuit connections, and a sixth section configured to receive second circuit connections;
the fifth sections of each region are diagonally opposed; and
the sixth sections of each region are diagonally opposed.

3. The housing of claim 2, wherein
each of the fifth and sixth sections occupy about half the available internal width of the housing.

4. The housing of claim 1, wherein:
the housing is configured to allow for the same volume within each region.

5. The housing of claim 1, wherein:
each second section is centrally disposed within the housing relative to the length of the housing, and are side by side each other relative to the width of the housing.

6. The housing of claim 2, wherein:
each second section is disposed between the respective first and sixth sections.

7. The housing of claim 1, wherein:
each third section occupies a substantial part of the available internal width of the housing.

8. The housing of claim 1, wherein:
both the first and third sections of each region are disposed at opposing ends of the housing relative to the length of the housing.

9. The housing of claim 2, wherein:
both the first and third sections of each region are disposed between the respective second and fifth sections.

10. A circuit breaker, comprising:
a single-pole housing, the housing having a length, width and height;
the housing comprising two current path regions, each region comprising a first section configured to receive an electromagnetic protection device, a second section configured to receive a thermal protection device, a third section configured to receive an arc extinguishing device, and a fourth section configured to receive an operating mechanism device;
two electromagnetic protection devices, each disposed within the first section of each current path region, each defining a portion of a current path within each current path region;
two thermal protection devices, each disposed within the second section of each current path region, each defining another portion of the current path within each current path region;
two arc extinguishing devices, each disposed within the third section of each current path region, each defining a further portion of the current path within each current path region; and
the operating mechanism device disposed within the fourth section of each current path region, the operating mechanism configured to open and close the current path of each current path region;
wherein each first section is disposed between the respective third and fourth sections;
wherein each first section occupies a substantial part of the available internal width of the housing; and
wherein each second section occupies about half the available internal width of the housing.

11. The circuit breaker of claim 10, wherein:
the two current path regions each further comprise a fifth section configured to receive first circuit connections, and a sixth section configured to receive second circuit connections;
the fifth sections of each region are diagonally opposed; and
the sixth sections of each region are diagonally opposed.

12. The circuit breaker of claim 11, wherein
each of the fifth and sixth sections occupy about half the available internal width of the housing.

13. The circuit breaker of claim 10, wherein:
each of the two current path regions are configured to occupy the same amount of volume within the housing.

14. The circuit breaker of claim 10, wherein:
each second section is centrally disposed within the housing relative to the length of the housing, and are side by side each other relative to the width of the housing.

15. The circuit breaker of claim 11, wherein:
each second section is disposed between the respective first and sixth sections.

16. The circuit breaker of claim 10, wherein:
each third section occupies a substantial part of the available internal width of the housing.

17. The circuit breaker of claim 10, wherein:
both the first and third sections of each region are disposed at opposing ends of the housing relative to the length of the housing.

18. The circuit breaker of claim 11, wherein:
both the first and third sections of each region are disposed between the respective second and fifth sections.

19. The circuit breaker of claim 10, wherein:
the operating mechanism device comprises a first portion and a second portion, the first portion being disposed within the fourth section of the first current path region, the second portion being disposed within the fourth section of the second current path region, the first and second portions being configured to allow tripping of the current path in the first and second current path regions together, the first and second portions being configured to allow manual opening and closing of the current path in the first and second current path regions together.
